(19) United States
(12) Patent Application Publication
(10) Pub. No.: US 2004/0266638 A1
(43) Pub. Date: Dec. 30, 2004

(54) Compositions and methods for management of toilet odor

(76) Inventors: Luz P. Requejo, Racine, WI (US); Daniel J. Masterson, Wonder Lake, IL (US)

Correspondence Address: S.C. JOHNSON & SON, INC., 1525 HOWE STREET, RACINE, WI, 53403-2236, US

(21) Appl. No.: 10/610,111

(22) Filed: Jun. 30, 2003

(51) Int. Cl. C11D 1/00

(52) U.S. Cl. 510/191

(57) ABSTRACT

Compositions and methods designed to manage toilet odor are disclosed. Compositions according to the present invention comprise a fragrance and other compounds for reacting with substances that cause toilet malodor. In one embodiment, the compound for reacting with toilet malodor is capable of selectively reacting with an osmogene and not the fragrance. In another embodiment, the compound is capable of binding osmogenes. In all embodiments, compositions of the present invention may be inserted into conventional toilets, either before, during or after use.

### FIELD OF THE INVENTION

This invention relates generally to compositions and methods for odor management, and more particularly to the management of toilet odor arising from osmogenes.

### SUMMARY OF THE INVENTION

Compositions and methods for the management of toilet odor are disclosed.

In one aspect, the composition of the present invention comprises a fragrance, a compound capable of selectively reacting with an osmogene and not the fragrance.

In another aspect, the present invention involves a process for managing toilet odor comprising the steps of providing a fragrance, providing a compound capable of binding an osmogene, adding the fragrance to the compound capable of binding an osmogene to form a mixture and adding the mixture to a toilet.

In still another aspect, the present invention involves a process for managing toilet odor comprising the steps of providing a fragrance, providing a compound capable of selectively reacting with an osmogene and not the fragrance, adding the fragrance to the compound capable of selectively reacting with an osmogene to form a mixture and adding the mixture to a toilet.

### DETAILED DESCRIPTION

Combination of a fragrance with a compound capable of reacting with an osmogene is an effective means of managing toilet odor. In one embodiment, the present invention comprises a fragrance and a compound capable of selectively reacting with an osmogene and not the fragrance. In a second embodiment, the present invention comprises a fragrance and a compound capable of binding an osmogene. The present invention is useful for managing odor in toilets. The composition of the present invention may or may not include aluminum salts.

According to the present invention, the fragrance is typically present in an amount of about 0.25% to about 10% by weight of the composition for managing toilet odor. Any known fragrance and/or perfume may be employed. Such fragrances include, but are not limited to, Allspice, Balsam, Bouquet, Christmas Pine, Citronella, Citrus Fresh, Citrus 7305 & 7309, Clean & Fresh, Cove, Deodorizer, Earth & Sea, Eucalyptus, Evergreen, any of the Floral series (3788, 9451, 8444, 4788, 9436 & 9940), Fresh & Clean 7902 & 8003, Fresh Outdoors, Gardenia, any of the Herbal series (8916, 4555, 8144 & 3719), Honeysuckle, Jasmin, any of the Lemon series (6001, 6039, 8136, 9413 & 9414), any of the Odor Mask series (5211, 6794, 7851, 8833, 8836, 8838, 8839, 8899 & 8899 w/s), any of the Pine series (9434, 8329 & 9435), Rose (9297 & 9298), Sandalwood, Sea Breeze, Spring Clean and Spring Rain, all available from The Good Scents Company, Atlanta, Ga.

Other fragrances and/or perfumes useful in the practice of the invention include the fragrances commonly used in the household and industrial cleaning and sanitizing industry. These fragrances may be found in the catalog Flavors & Fragrances, and are available from the Aldrich Chemical Company, Inc., Milwaukee, Wis. Those of particular interest are Alpha Pinene, Alpha Terpineol, Beta Pinene, Cedar Leaf, Citral, Citronellal W23070-7, Coumarin, Diethylphthalate, Eucolyptol, Eugenol, Heptyl Isobutyrate, Trans-2-Hexene-Diol, Isobornyl and 3,5,5-Trimehtylhexanal.

The compound capable of selectively reacting with an osmogene and not the fragrance helps manage toilet odor while not interfering with the fragrance. In certain embodiments, the compound capable of selectively reacting with the osmogene binds with the osmogene to manage its malodorous effect. In other embodiments, the compound capable of selectively reacting with the osmogene helps to mask toilet malodor. The compound may be present in an amount of about 0.1% to 10% by weight of the composition for managing toilet odor. In one embodiment, the compound is zinc ricinoleate, though other suitable compounds known to those of skill in the art may also be employed.

The compound capable of binding an osmogene also helps to manage toilet odor. This compound may also be present in an amount of about 0.1% to 10% by weight. Examples include, but are not limited to activated carbon, zeolites and baking soda.

The term osmogene is defined broadly herein to mean any compound or substance that causes toilet malodor. Typical examples include, but are not limited to hydrogen sulfide, sulfur dioxide, diphenyl sulfide, mercaptane, thioether, isovaleric acid, skatole, putrascine, thiophenols and ammonia.

As previously mentioned, the composition of the present invention is capable of being inserted into all toilets, either before, during or after use, to manage and/or sanitize odors. This includes toilets found in all settings with and without water holding tanks. The invention may also be used to sanitize or control odor in waste water systems.

In other aspects of the present invention, the composition for managing toilet odor may optionally include other components.

For example, in one embodiment of the present invention, the composition for managing toilet odor includes a composition capable of effervescence. The term “effervescence,” as defined herein, means forming bubbles in liquid environments and may also be considered any product capable of liberating carbon dioxide in or out of liquid environments.

In certain embodiments, the presence of bubbles results from the formation of carbon dioxide, which is also helpful in the management of toilet odor. That is, some malodors have high molecular weights and therefore cannot rise to the surface of an aqueous environment to escape into the atmosphere before carbon dioxide. Thus, in embodiments of the present invention that emit carbon dioxide, odors with high molecular weights are suppressed.

The production of carbon dioxide may be accomplished through a mixture of at least one acid and at least one salt, which when added to a liquid such as water, results in a chemical reaction that liberates carbon dioxide. In one aspect, both the acid and the salt may be in anhydrous form.

Examples of acids suitable for use in illustrative embodiments include, but are not limited to, tartaric acid, citric acid, fumaric acid, adipic acid, malic acid, oxalic acid, or sulfamic acid, either alone or in combination. Typically, the acid citric acid or a combination of citric acid and tartaric acid.

Examples of salts suitable for use in illustrative embodiments include, but are not limited to, the alkali metal salts. Sodium carbonate, calcium carbonate, magnesium carbonate, ammonium carbonate, potassium carbonate, sodium bicarbonate, and calcium bicarbonate may all be employed.

In other embodiments, the selection of specific acids and/or salts and their proportions depends, at least in part, upon the requirements for the amount of carbon dioxide release. In some embodiments, the acid may be added in an amount of about 10% to about 60% by weight of the composition for managing toilet odor, while the salt may be added in an amount of about 10% to 70% by weight of the selective odor suppressant.

In other embodiments, compositions according to the present invention may include a solvent, which in select embodiments, may be added to in an amount of up to 10% by weight of the composition for managing toilet odor. The ratio of the acid/salt component to solvent should not, however, be less than 9:1. If the ratio of the acid/salt component to the solvent falls below 9:1, the final formulation may form a sticky mixture or slurry.

Often, but not always, the solvent is contained within the fragrance. As those of skill will appreciate, fragrances typically comprise highly concentrated solid ingredients. The presence of the solvent may be necessary to dissolve, disperse or mix these solid ingredients to make the fragrance homogenous throughout. Since fragrance manufacturers often incorporate solvents directly into their fragrances, coordinating solvent selection with the fragrance manufacturer may be necessary.

The solvent may be non-hygroscopic, defined herein as not taking up moisture from the environment. Suitable non-hygroscopic solvents include, but are not limited to diethyl phthalate, isopropyl myristate, isopropyl palmitate and at least some species of ester solvents, such as dioctyl adipate and butyl stearate. Since neither the effervescent component nor the non-hygroscopic solvent absorb moisture, in these embodiments, the formation of bubbles is substantially avoided until the composition for managing toilet odor is contacted by a liquid, such as water. That is, moisture from the environment does not precipitate a premature reaction between the acid and salt of the present invention before these chemical constituents come into contact with liquids.

In other embodiments, the non-hygroscopic solvent may be non-aqueous or non-polar (aprotic). With respect to the non-aqueous aspect, the absence of water from the selective odor suppressant substantially avoids the formation of bubbles until the effervescent is contacted by a liquid. Regarding the absence of polarity, this feature avoids dissociation of the salt, which under certain circumstances, may trigger a pre-mature reaction between the acid and carbonate or bicarbonate components of the effervescent component.

The composition for managing toilet odor may further include a colorant. The colorant may be oil- or water-soluble, and typically is an anhydrous powder dye. The amount of colorant to be used may depend on the color intensity desired and the cost of the dye, and may be added at levels up to about 2.0% by weight of the composition for managing toilet odor. When the composition for managing toilet odor includes a colorant, but not an effervescent component, a small amount of water for dissolving the colorant may be added. The water is present in an amount of no more than about 1.0% by weight of the composition for managing toilet odor.

The choice of the colorant will depend largely on the color desired for the water into which the effervescent is to be dispensed. Examples of suitable water-soluble colorants include, but are not limited to, acid blue #9, Basacid Blue NB 755®, FD&C yellow #5, FD&C Red #33, and D&C Green #8. Oil-soluble colorants include, but are not limited to, Nitro Fast Red A 4B®, solvent yellow 72 and Sandoplast Green G®.

In addition, the composition for managing toilet odor may further comprise a surfactant. A surfactant is any substance capable of reducing surface tension, no matter how slight, between phases. Similar to the colorant, the surfactant is typically added in anhydrous form. In some embodiments, the surfactant may be added at levels ranging from about 0.5% to about 10% by weight of the composition for managing toilet odor. In other embodiments, the surfactant imparts a detergent effect to the present invention.

Surfactants useful with the present invention include anionic, non-ionic, cationic, amphoteric and zwitterionic surfactants. Anionic surfactants are particularly useful, since such surfactants are capable of forming a thick foam or lather during liberation of carbon dioxide by the effervescent component.

Examples of suitable surfactants include, but are not limited to sodium lauryl sulfonate, sodium alpha olefin sulfonate, alkyl benzene sulfonate, sodium dodecyl benzene sulphonate and cocoyl glutamic acid. Other types of surfactants include alkyl benzene sulfonates, alkyl ether sulfates, paraffin, sulfonates, olefin sulfonates, amine oxides, alkyl betaines and the like, which are known in the art. Commercial sources of such surfactants may be found in McCutcheon's Emulsifiers and Detergents, North American Edition, 1987, McCutcheon Division, (MC Publishing Company).

An absorbing or flowing agent may also be added to the composition of the present invention, in an amount of about 0.1% to about 15% by weight. The absorbing or flowing agent is useful for preventing the premature reaction between the acid and carbonate or bicarbonate components of the composition, and typically is a compound comprising silica (silicon dioxide). Generally, magnesium carbonate is employed. Other examples of absorbing agents, include but are not limited to, amorphous silica, foamed silica and synthetic silica.

The various forms of the composition for managing toilet odor may be contained in a reagent vessel. A reagent vessel is capable of containing or holding the composition of the present invention. For example, the reagent vessel may be a sealed pouch, dissolvable in water. In such embodiments, the reagent vessel may be constructed from a permeable filter paper-like material (e.g. the material used in tea bags). This type of material permits the components to leave the reagent vessel after insertion into the toilet so that the components may react in the toilet water.

The reagent vessel may also be constructed of foil, plastic or any other type of material that will hold the composition of the present invention before insertion into a toilet. Such materials include, but are not limited to polyethylene, polypropylene, polystyrene and polyethylene-terephtalate. In these embodiments, the reagent vessel may be discarded prior to addition of the composition of the present invention into the toilet. For instance, the various forms of the composition may be packaged in a single use package, which may be carried in one's purse or pocket. When using a public restroom or a friend's bathroom, the user may open the package containing the composition of the present invention, and dispense its contents into the toilet.

When the composition of the present invention includes an effervescent component and is contained within a reagent vessel, it is particularly useful to substantially avoid bubbling by the effervescent component until it contacts a liquid. More specifically, when bubbling results in carbon dioxide formation, the presence of carbon dioxide gas may exert pressure on the reagent vessel causing it to explode and/or prematurely release its contents before being inserted into a toilet. Under these circumstances, the entire composition for managing toilet odor may be rendered unusable and/or potentially injure the user.

In still other embodiments, a dispensing apparatus for delivering the composition of the present invention into a toilet may be employed. The dispensing apparatus may, for example, be attached to any solid surface on or above a toilet and may comprise a container connected to a tube or other device for delivering the composition from the container into the toilet bowl. The dispensing apparatus may be operated by depressing a button or any other suitable means that will dispense appropriate amounts of the composition for controlling toilet odor.

Additionally, the composition for managing toilet odor may include filler material to make the formula more affordable. Examples of suitable fillers include, but are not limited to sodium sulfate, and sodium chloride.

The various forms of the composition for managing toilet odor may be contained in a reagent vessel. A reagent vessel is capable of containing or holding the composition of the present invention. For example, the reagent vessel may be a sealed pouch, dissolvable in water. In such embodiments, the reagent vessel may be constructed from a permeable filter paper-like material (e.g. the material used in tea bags). This type of material permits the components to leave the reagent vessel after insertion into the toilet so that the components may react in the toilet water.

The reagent vessel may also be constructed of foil, plastic or any other type of material that will hold the composition of the present invention before insertion into a toilet. Such materials include, but are not limited to polyethylene, polypropylene, and polyethylene-terephtalate. In these embodiments, the reagent vessel may be discarded prior to addition of the composition of the present invention into the toilet. For instance, the various forms of the composition may be packaged in a single use package, which may be carried in one's purse or pocket. When using a public restroom or a friend's bathroom, the user may open the package containing the composition of the present invention, and dispense its contents into the toilet.

When the composition of the present invention includes an effervescent component and is contained within a reagent vessel, it is particularly useful to substantially avoid bubbling by the effervescent component until it contacts a liquid. More specifically, when bubbling results in carbon dioxide formation, the presence of carbon dioxide gas may exert pressure on the reagent vessel causing it to explode and/or prematurely release its contents before being inserted into a toilet. Under these circumstances, the entire composition for managing toilet odor may be rendered unusable and/or potentially injure the user.

In still other embodiments, a dispensing apparatus for delivering the composition of the present invention into a toilet may be employed. The dispensing apparatus may, for example, be attached to any solid surface on or above a toilet and may comprise a container connected to a tube or other device for delivering the composition from the container into the toilet bowl or tank. The dispensing apparatus may be operated by depressing a button or any other suitable means that will dispense appropriate amounts of the composition for controlling toilet odor.

In other aspects, the present invention involves methods of making the composition for managing toilet odor described herein. In illustrative embodiments, compositions according to the present invention may be prepared in a V-blender or a ribbon blender.

If a V-blender is employed, in one embodiment, a fragrance and a compound capable of binding an osmogene or a compound capable of selectively reacting with an osmogene and not the fragrance are mixed together in the blender. Additional components, such as filler materials, may also be added. In embodiments that comprise an effervescent component, a salt and citric acid are first added to the V-blender. Mixing of the compounds for approximately fifteen minutes occurs, followed by addition of the fragrance and further mixing. Finally, the compounds that react with osmogenes are added, followed by mixing until substantially homogeneous. Optionally, additional materials may be added to any of the formulations. For example, a surfactant, a flowing agent, a solvent for the fragrance or a dye may be incorporated into the process. In most cases, however, the compound capable of reacting with the osmogene should be added last.

A ribbon blender may also be employed. This processing method is faster and more efficient. In embodiments using a ribbon blender, the chemical constituents may be added simultaneously, followed by mixing.

Regardless of the type of blender employed, external conditions, such as temperature and humidity, should be monitored throughout the process of making the composition of the present invention. Ideally, manufacture of the composition is carried out at temperatures between 18° C. and 30° C. and at lower relative humidities, up to a maximum of 40% for example, with a preferred relative humidity below 25%.

Typically, the above-described method of making yields the composition of the present invention in powder form. The composition may, however, be supplied in various other forms, such as tablet form, block form, cake form, capsule or gel form, and any other form known to those of skill in the art. To make tablet, block or cake forms, the powder form may be compressed by methods known to those of skill in the art. Size and hardness are dependent on the mold size and pressure used during the compression process. If a liquid form is desired, in some cases it is necessary to employ a dual bottle with two compartments to separate the effervescent components of the invention.

Variations, modifications and other implementations of what is described herein will occur to those of ordinary skill in the art without departing from the spirit and scope of the invention. Accordingly, the invention is in no way limited by the preceding illustrative description.

### Industrial Applicability

The present invention has applicability in the management of odor in toilets This includes toilets found in all settings with and without water holding tanks. The present invention may also be used to sanitize or control odor in waste water systems.

I claim:

1. A composition for managing toilet odor comprising:
a fragrance; and
a compound capable of selectively reacting with an osmogene and not the fragrance.

2. The composition of claim 1, wherein the compound capable of selectively reacting with an osmogene and not the fragrance is zinc ricinoleate.

3. The composition of claim 1, wherein the osmogene is selected from the group consisting of hydrogen sulfide, sulfur dioxide, diphenyl sulfide, mercaptane, thioether, isovaleric acid, skatole, putrascine, thiophenols and ammonia.

4. The composition of claim 1, wherein the compound capable of selectively reacting with an osmogene and not the fragrance binds the osmogene.

5. The composition of claim 1, wherein the compound capable of selectively reacting with an osmogene helps to mask toilet malodor.

6. The composition of claim 1, further comprising an effervescent component comprising an acid and a salt.

7. The composition of claim 6, wherein the acid is citric acid and the salt is an alkali metal carbonate.

8. The composition of claim 1, further comprising a non-hygroscopic solvent selected from the group consisting of diethyl phthalate, isopropyl myristate, isopropyl palmitate, dioctyl adipate and butyl stearate.

9. The composition of claim 1, further comprising a colorant.

10. The composition of claim 1, further comprising a surfactant.

11. The composition of claim 1, further comprising an absorbing agent.

12. The composition of claim 1, wherein the composition is in powder form.

13. The composition of claim 1, wherein the composition does not include an aluminum salt.

14. A process for managing toilet odor comprising:
providing a fragrance;
providing a compound capable of binding an osmogene; and
adding the fragrance to the compound capable of binding an osmogene to form a mixture; and
adding the mixture to a toilet.

15. The process of claim 14, wherein the compound capable of binding an osmogene is selected from the group consisting of activated carbon, zeolites and baking soda.

16. The process of claim 14, wherein the osmogene is selected from the group consisting of hydrogen sulfide, sulfur dioxide, diphenyl sulfide, mercaptane, thioether, isovaleric acid, skatole, putrascine, thiophenols and ammonia.

17. The process of claim 14, wherein the compound capable of binding an osmogene helps to mask toilet malodor.

18. The process of claim 14, further comprising adding an effervescent component comprising an acid and a salt to the mixture.

19. The process of claim 18, wherein the acid is citric acid and the salt is an alkali metal carbonate.

20. The process of claim 14, further comprising adding a non-hygroscopic solvent selected from the group consisting of diethyl phthalate, isopropyl myristate, isopropyl palmitate, dioctyl adipate and butyl stearate to the mixture.

21. The process of claim 14, further comprising adding a colorant to the mixture.

22. The process of claim 14, further comprising adding a surfactant to the mixture.

23. The process of claim 14, further comprising adding an absorbing agent to the mixture.

24. The process of claim 14 wherein the mixture is in powder form.

25. A process for managing toilet odor comprising the steps of:
providing a fragrance;
providing a compound capable of selectively reacting with an osmogene and not the fragrance;
adding the fragrance to the compound capable of selectively reacting with an osmogene to form a mixture; and
adding the mixture to a toilet.

26. The process of claim 25, wherein the compound capable of selectively reacting with an osmogene and not the fragrance is zinc ricinoleate.

27. The process of claim 25, wherein the osmogene is selected from the group consisting of hydrogen sulfide, sulfur dioxide, diphenyl sulfide, mercaptane, thioether, isovaleric acid, skatole, putrascine, thiophenols and ammonia.

28. The process of claim 25, wherein the compound capable of selectively reacting with an osmogene and not the fragrance binds the osmogene.

29. The process of claim 25, wherein the compound capable of selectively reacting with an osmogene helps to mask toilet malodor.

30. The process of claim 25, further comprising adding an effervescent component comprising an acid and a salt to the mixture.

31. The process of claim 30, wherein the acid is citric acid and the salt is an alkali metal carbonate.

32. The process of claim 25, further comprising adding a non-hygroscopic solvent selected from the group consisting of diethyl phthalate, isopropyl myristate, isopropyl palmitate, dioctyl adipate and butyl stearate to the mixture.

33. The process of claim 25, further comprising adding a colorant to the mixture.

34. The process of claim 25, further comprising adding a surfactant to the mixture.

35. The process of claim 25, further comprising adding an absorbing agent to the mixture.

36. The process of claim 25, wherein the mixture is in powder form.
